(19) United States
(12) Patent Application Publication
(10) Pub. No.: US 2025/0300751 A1
(43) Pub. Date: Sep. 25, 2025

(54) A METHOD OF FAST PATH LOSS CALCULATION CONSIDERING ENVIRONMENTAL FACTORS

(71) Applicant: Ranplan Wireless Network Design Ltd, Cambridge (GB)

(72) Inventors: Jie ZHANG, Cambridge (GB); Kehai QIU, Cambridge (GB); Hanye HU, Cambridge (GB); Jiming CHEN, Cambridge (GB)

(21) Appl. No.: 18/863,530

(22) PCT Filed: May 4, 2023
(86) PCT No.: PCT/GB2023/051186

§ 371 Date: Nov. 6, 2024

(30) Foreign Application Priority Data
May 6, 2022 (GB) 2206684.9

(51) Int. Cl. H04B 17/391; H04B 17/20; H04B 17/309

(52) U.S. Cl. CPC H04B 17/3912; H04B 17/253; H04B 17/347

(57) ABSTRACT

The present invention relates to a novel radio propagation path loss calculation method considering environmental factors comprehensively, including building, road, foliage, pedestrians, etc. In an example, the path loss calculation method includes the steps of segmenting the scenario of interest into several regions, assigning each region with a path loss exponent, generating straight-line path information between the Tx region and the Rx region, calculating the path loss by accumulating the weighted path loss of each region in the straight-line path and updating the environmental factor-related path loss exponent using measurement data. A major contribution of this invention is the introduction of the path loss exponent related to each environmental factor, which enables a fast and accurate path loss calculation.

### FIELD OF THE INVENTION

The present invention generally relates to wireless communications. More particularly, the present invention relates to a method of calculating the radio propagation path loss in outdoor scenarios with low computational complexity. The invention comprehensively considers environmental factors, including, but not limited to, buildings, trees, foliage, street furniture, pedestrians, weather conditions, etc.

### TECHNICAL BACKGROUND

Radio propagation path loss calculation plays a key role in wireless network planning and optimization. This work, traditionally carried out by radio frequency (RF) engineers exploiting physical and statistical propagation models, is labour-intensive and time-consuming, especially for a large outdoor area. It is also very costly to rectify the under-dimensioning or over-dimensioning of a radio access network due to path loss errors after the radio access network has been deployed. Thus, an efficient, cost-effective and accurate radio propagation path loss model is highly desirable.

Currently, deterministic and empirical models are the two most widely used categories of radio propagation models. Ray-tracing models (e.g., as described in V. Degli Esposti, “Ray tracing: techniques, applications and prospect,” in 2020 International Symposium on Antennas and Propagation (ISAP), pp. 307-308) and ray-launching models (e.g., as described in B. E. Gschwendtner, G. Wolfle, B. Burk, and F. M. Landstorfer, “Ray tracing vs. ray launching in 3-D microcell modelling,” 1995.), belonging to the former, are based on the ray optics; they numerically solve the Maxwell's equations by considering multiple paths propagation. Ray-tracing models compute rays backwards from receiver (Rx) to transmitter (Tx), while ray-launching models compute rays the other way round, i.e., from Tx to Rx. The accuracy of these models depends on a few factors such as the ray intensity, modelling of propagation phenomenon, resolution of maps, etc. One drawback of the deterministic models is that they consume a large amount of computation resources and time. Empirical models, such as Okumura-Hata model (e.g., as described in T. S. Rappaport, Wireless communications: principles and practice, vol. 2. Prentice Hall PTR New Jersey, 1996), Stanford University Interim (SUI) model (e.g., as described in S. I. Umana, N. O. Akpbio, and S. E. Mbong, “Extended Stanford University Interim Model Loss Stanford University Interim Propagation Loss Model for a Gmelina Arborea Tree-Lined Road,” Rev. Comput. Eng. Res., vol. 5, no. 2, pp. 57-63, 2018), and COST-231 Hata model (e.g., as described in R. V Akhpashev and A. V Andreev, “COST 231 Hata adaptation model for urban conditions in LTE networks,” in 2016 17th International Conference of Young Specialists on Micro/Nanotechnologies and Electron Devices (EDM), pp. 64-66), use a simple formula to calculate path loss for a certain type of typical scenario at the expense of accuracy. The path loss calculated using the empirical models is only related to a few parameters including a scenario-related path loss exponent, which is applied to the whole scenario, and the distance between the Tx and the Rx, etc. However, empirical models are only valid to the same type of environments that the models are trained for. Applying an empirical model to a different type of environment results in a large root mean square error (RMSE) of over 10 dB or more.

As environmental factors are difficult to model, several parameterized models for path loss prediction have been proposed, including MiWEBA channel model (e.g., as described in A. Maltsev et al., “Channel modeling and characterization,” Deliv. FP7-ICT, vol. 368721, p. D5, 2014), QuaDRiGa (e.g., as described in S. J. et al., QuaDRiGa—Quasi deterministic radio channel generator, user manual and documentation. 2017), mmMAGIC channel model (e.g., as described in M. Peter, K. Haneda, S. L. H. Nguyen, A. Karttunen, and J. Järveläinen, “Measurement results and final mmMAGIC channel models,” Deliv. D2, vol. 2, p. 12, 2017), METIS channel model (e.g., as described in V. Nurmela et al., “Deliverable D1. 4 METIS channel models,” Proc. Mob. Wirel. Commun. Enablers Inf. Soc. (METIS), p. 1, 2015), 5GCMSIG (e.g., as described in A. Univ, 5G channel model for bands up to 100 GHz, v2.0. 2014), 3GPP channel model (e.g., as described in S. Antipolis, “Study on channel model for frequencies from 0.5 to 100 GHZ (release 14) V14.0.0,” vol. Rep. TR 38. 2017), IMT-2020 channel model (e.g., as described in I. Telecommun, “Preliminary Draft New Report ITU-R M. [IMT-2020.EVAL],” vol. document R. 2017) and the more general 5G channel model (MG5GCM) (e.g., as described in S. Wu, C.-X. Wang, M. M. Alwakeel, and X. You, “A general 3-D non-stationary 5G wireless channel model,” IEEE Trans. Commun., vol. 66, no. 7, pp. 3065-3078, 2017). The values of the parameters in these models can be either extracted from measurement data or supplied by ray-tracing simulation results (e.g., as described in C.-X. Wang, J. Bian, J. Sun, W. Zhang, and M. Zhang, “A survey of 5G channel measurements and models,” IEEE Commun. Surv. Tutorials, vol. 20, no. 4, pp. 3142-3168, 2018). Among these models, the MiWEBA channel model, the mmMAGIC channel model, the METIS channel model, the 5GCMSIG, the 3GPP channel model and the IMT-2020 channel model accommodate propagation characteristics of blockage and gaseous absorption which can be extended to incorporate the high blockage effect due to environmental factors. Furthermore, the IMT-2020 channel model also incorporates impacts of vegetation. However, a comprehensive channel model incorporating environmental factors with low computational complexity is still missing.

### SUMMARY OF THE INVENTION

To overcome the aforementioned shortcomings and deficiencies of the existing radio propagation models, the present invention provides a method of outdoor radio propagation path loss calculation based on parametrized environmental factors.

The invention relates to a path loss model that can compensate for the disadvantages of the above path loss calculation models. The model can capture all the environmental factors and calculate the path loss with low computational complexity. The steps of developing such a model may include the following:
1. A raster map, including but not limited to forms of satellite image and Geographic Information System (GIS), is divided into several regions, which may comprise an arbitrary number of horizontally and vertically consecutive pixels and are of an arbitrary shape.
2. Each region is labelled with an environmental factor either manually by a person or automatically by using digital image processing techniques. The region-wise labels are parameterized to predict the radio propagation path loss.
3. A straight-line path between a Tx (a transmitter, e.g., a base station) and a Rx (a receiver, e.g., a mobile terminal) is generated; the environmental factor of and the path distance within each region that the path travelled are recorded.
4. The path loss between the Tx and Rx is calculated by accumulating the path loss (in dB) of each region in the straight-line path.
5. Measurement data of the same scenario is used to modify the value of the path loss exponent related to each environmental factor, for example, by minimizing the sum of squared error between the measured and predicted values of the path loss in each region and/or by minimizing the sum of squared error between the measured and predicted values of the path loss.

According to a first aspect of the invention, there is provided a method of radio path loss calculation considering parameterized environmental factors, the method comprising:
(a) segmenting a scenario of interest into a plurality of regions;
(b) labelling each region with an environmental factor, wherein the environmental factor of each region is mapped to a path loss exponent;
(c) initializing a path loss exponent for each region;
(d) for each of a plurality of pairs of transmitter and receiver in the scenario of interest, generating straight-line path information, including a straight-line path between a transmitter (Tx) and a receiver (Rx) in the scenario of interest;
(e) for each of the plurality of pairs of transmitter and receiver in the scenario of interest, calculating the path loss between the transmitter (Tx) and the receiver (Rx) by accumulating the path loss of each region crossed by the straight-line path between that transmitter (Tx) and that receiver (Rx), so as to obtain calculated values;
(f) for each of the plurality of pairs of transmitter and receiver in the scenario of interest, obtaining a measure of the path loss between the transmitter (Tx) and the receiver (Rx), so as to obtain measurement data;
(g) updating the environmental factor-related path loss exponent of each region in dependence on the calculated values and the measurement data;
(h) iterating the steps (e) to (g) until predefined termination criteria are reached; and
(i) outputting the updated path loss exponent of each region for future path loss prediction or training.

In an example, there is provided a method of radio propagation path loss calculation considering parameterized environmental factors, the method comprising:
a) segmenting a 2-dimensional or 3-dimensional scenario of interest (e.g. area or volume) into several regions;
b) labelling each region with an environmental factor, wherein the environmental factor of each region is considered as path loss exponent;
c) initializing a path loss exponent for each region;
d) generating a straight-line path information between a Transmitter (Tx) region and a Receiver (Rx) region;
e) calculating the path loss by accumulating the path loss of each region in the straight-line path;
f) updating the environmental factor related path loss exponent of each region using measurement data;
g) iterating step e) and f) until the predefined termination criteria are reached; and
h) saving the path loss exponent of each region for future path loss prediction or training reference.

In another example, there is provided a method of radio path loss calculation considering parameterized environmental factors, the method comprising:
a) segmenting a scenario of interest into a plurality of regions;
b) labelling each region with an environmental factor, wherein the environmental factor of each region is mapped to a path loss exponent;
c) initializing a path loss exponent for each region;
d) generating straight-line path information, including a straight-line path between a transmitter (Tx) and a receiver (Rx) in the scenario of interest;
e) calculating the path loss between the transmitter and the receiver by accumulating the path loss of each region crossed by the straight-line path;
f) updating the environmental factor-related path loss exponent of each region using measurement data;
g) iterating the steps e) and f) until predefined termination criteria are reached; and
h) outputting the updated path loss exponent of each region for future path loss prediction or training.

The method can be applied to any frequency band.

Each region may comprise one or more pixels and may be regular or irregular in shape, and wherein each region may comprise any one or more of: a building, a group of buildings, a group of foliage, one or more humans, one or more vehicles, or other objects.

The environment factors may include any one or more of: building(s), road(s), foliage, rain, snow, vehicle(s), human(s), furniture, landscaping, terrain, climatic conditions, or other obstacles.

A pixel-wise labelling method may be used to perform the labelling step (b), the pixel-wise labelling method including any one or more of the following approaches:
manual labelling;
automatic labelling using algorithms based on a machine learning framework to recognise geographic information, optionally wherein the said machine learning framework is a neural network (NN) method.

In the labelling step (b), a label for each region may be calculated based on:
a mean greyscale value of all the pixels that that region consists of; or
a weighted greyscale value of all the pixels that that region consists of.

Initializing the path loss exponent for each region may include any one or more of the following approaches:
initializing the path loss exponent based on a pre-trained model;
initializing the path loss exponent randomly;
initializing the path loss exponent manually;
initializing the path loss exponent based on measurement data; and
initializing the path loss exponent based on theoretically calculated values.

Generating the straight-line path information between the Tx and the Rx may comprise generating a matrix comprising the straight-line path information, the matrix having the form:

$$( \begin{matrix}{X}_{1} ( {X}_{S} ) & {X}_{2} & {X}_{3} & & {X}_{{N}_{k} - 2} & {X}_{{N}_{k} - 1} & {X}_{{N}_{K}} ( {X}_{{D}_{k}} ) \\ {Y}_{1} ( {X}_{S} ) & {Y}_{2} & {Y}_{3} & … & {Y}_{{N}_{k} - 2} & {Y}_{{N}_{k} - 1} & {Y}_{{N}_{K}} ( {Y}_{{D}_{k}} ) \\ {d}_{1} & {d}_{2} & {d}_{3} & & {d}_{{N}_{k} - 2} & {d}_{{N}_{k} - 1} & {d}_{{N}_{k}}\end{matrix} )$$

where the straight line, starting from the Tx region (X_{S}, Y_{S}) and ending at the Rx region (X_{D}_{ₖ}, Y_{D}_{ₖ}), crosses Nₖ regions in total, the first and second rows denote the X and Y coordinates of the Nₖ regions, respectively, (X₁, Y₁) is the position of the Tx and (X_{N}_{ₖ}, Y_{N}_{ₖ}) is the position of the Rx, and the third row denotes the distance of the path travelled within in each one of the Nₖ regions.

The path loss PLᵢ of the i-th region in the straight-line path may comprise:
the path loss experienced at the region of the Tx, calculated as:

PL₀=C
where C is a constant; and
the path loss experienced at each one of the other regions, calculated as:

$${PL}_{i} = 10 * {n}_{i} * {log}_{10} ( \frac{{Σ}_{j = 0}^{i} {d}_{j}}{{Σ}_{j = 0}^{i - 1} {d}_{j}} )$$

where nᵢ is the path loss exponent of region i, which is dependent on the environmental factor for that region, dⱼ is the distance of the path within region j, Σⱼ₌₀ⁱdⱼ is the distance of the path from the region of the Tx to region i, and

$${log}_{10} ( \frac{{\sum }_{j = 0}^{i} {d}_{j}}{{\sum }_{j = 0}^{i - 1} {d}_{j}} )$$

is the ratio between the distance from region i to the region of the Tx and the distance from region i−1 to the region of the Tx.

The path loss experienced in each region may be accumulated to calculate the total path loss, i.e. PL, between the Tx and the Rx, calculated as:

$$P L = {\sum }_{i = 0}^{N} P {L}_{i}$$

Updating the environmental factor-related path loss exponent may further comprise:
for each region, calculating an error between the measurement data and the path loss calculated in the calculating step (e); and
updating the environmental factor-related path loss exponent of each region in dependence on the calculated errors.

The error between the measurement data and the path loss calculated in the calculating step (e) may be computed using any of the following errors:
the sum of all of the absolute differences between the measured values and the calculated values;
the sum of all of the squared differences between the measured values and the calculated values; or
the minimum mean square error (MMSE) between the measured values and the calculated values.

Updating the environmental factor-related path loss exponent of each region may include any of the following approaches:
manually updating;
updating using optimization algorithms, which include any one or more of simulated annealing, or genetic algorithm;
updating using machine learning algorithms, which include any one or more of neural network methods, or reinforcement learning methods.

The predefined termination criteria may include any of the following criteria:
the error being smaller than a threshold;
the error keeping constant after several consecutive epochs; or
a maximum number of running epoch is reached.

The path loss exponent of each region can be an attribute of a digital map in any format such as Google Maps, Bing Maps, Street Maps, and any Geographic Information Systems.

### BRIEF DESCRIPTION OF THE DRAWINGS

The present invention will now be described by way of example with reference to the accompanying drawings. In the drawings:

FIG. 1 shows a block diagram of the method of path loss calculation using parameterized environmental factors according to the principles described herein.

FIG. 2 shows a block diagram of generating the path between the transmitter (i.e., “Tx”) and all of the receivers (i.e. “Rx”).

FIG. 3 shows the path generation between the Tx and the Rx.

FIG. 4 shows an example figure with greyscale labels of building, foliage, road, etc.

### DETAILED DESCRIPTION OF THE INVENTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a novel radio propagation path loss calculation method considering environmental factors comprehensively, e.g. including building, road, foliage, pedestrians, etc. In an example, the path loss calculation method includes the steps of segmenting the scenario of interest (e.g. area or volume) into several regions, assigning each region with a path loss exponent, generating a straight-line path information between the Tx region and the Rx region, calculating the path loss by accumulating the weighted path loss of each region in the straight-line path and updating the environmental factor-related path loss exponent using measurement data. A major contribution of this invention is the introduction of the path loss exponent related to each environmental factor, which enables a fast and accurate path loss calculation.

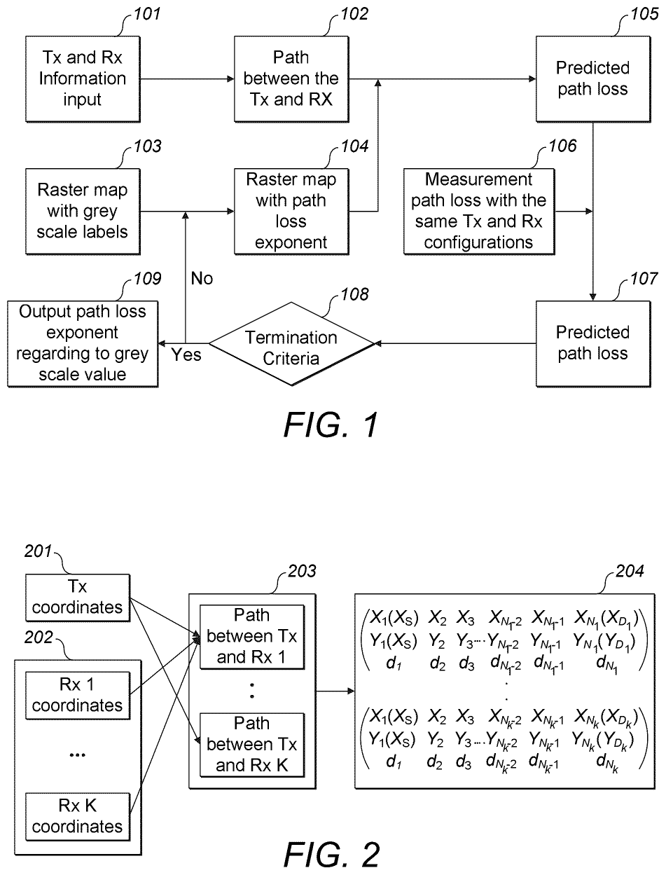

The block diagram of the invention can be found in FIG. 1. The 3D coordinates of the transmitter (i.e., “Tx”) and receivers (i.e., “Rx”) in 101 are used to generate the path between the Tx and all of the Rx in 102, each path contains all the distances travelled in all the regions from the region where the Tx is located to the region where the Rx is located. A raster map with either red, green and blue (RGB) or red, green, blue and depth (RGBD) values in 103 is converted into a raster map with regional information via manual labelling or automated labelling and then allocating a path loss exponent to each region. The allocation can be random or based on previous learning. The path between the Tx and all of the Rx in 102 along with the raster map with path loss exponent in 104 are used to calculate the path loss between the Tx and all of the Rx in 105. Measured path loss data for the same scenario, and Tx and Rx configurations in 106 are used to compute the loss function in 107 based on the path loss exponent in 104. The loss function in 107 can be computed as, but not limited to, L1 error (i.e., the sum of the all the absolute differences between the true (e.g. measured) value and the predicted (e.g. calculated) value), L2 error (i.e., the sum of all the squared differences between the true (e.g. measured) value and the predicted (e.g. calculated) value) or minimum mean square error (MMSE) (e.g. between the measured values and the calculated values). If the loss function in 107 fulfils the termination criteria in 108, then the path loss exponent regarding each region is outputted in 109 for future path loss calculation. If the termination criteria in 108 are not fulfilled, the path loss exponent for each region in 104 is updated according to a certain algorithm, which will be described later.

FIG. 2 demonstrates how the paths between a transmitter (i.e., “Tx”) and all of the receivers (i.e., “Rx”) in 101 in FIG. 1 are generated. The position of the Tx (X_{S}, Y_{S}) in 201 and the positions of all of the K Rx ((X_{D}_{₁}, Y_{D}_{₁}), . . . , (X_{D}_{_{K}}, Y_{D}_{_{K}})) in 202 are used to generate the paths between the Tx and each one of the Rx as shown in FIG. 2. The path between the Tx and the k-th Rx in 203 is the straight line starting from (X_{S}, Y_{S}) and ending at (X_{D}_{ₖ}, Y_{D}_{ₖ}), which crosses NR regions. A 3 by Nₖ matrix in 204 containing the information of the path between the transmitter and the k-th Rx can be generated as follows:

$$( \begin{matrix}{X}_{1} ( {X}_{S} ) & {X}_{2} & {X}_{3} & & {X}_{{N}_{k} - 2} & {X}_{{N}_{k} - 1} & {X}_{{N}_{K}} ( {X}_{{D}_{k}} ) \\ {Y}_{1} ( {X}_{S} ) & {Y}_{2} & {Y}_{3} & … & {Y}_{{N}_{k} - 2} & {Y}_{{N}_{k} - 1} & {Y}_{{N}_{K}} ( {Y}_{{D}_{k}} ) \\ {d}_{1} & {d}_{2} & {d}_{3} & & {d}_{{N}_{k} - 2} & {d}_{{N}_{k} - 1} & {d}_{{N}_{k}}\end{matrix} ) \qquad ( 1 )$$

where the first and second rows denote the X and Y coordinates of the Nₖ regions, respectively. (X₁, Y₁) is the position of the Tx and (X_{N}_{ₖ}, Y_{N}_{ₖ}) is the position of the Rx. The third row denotes the distance of the path within each one of the NR regions.

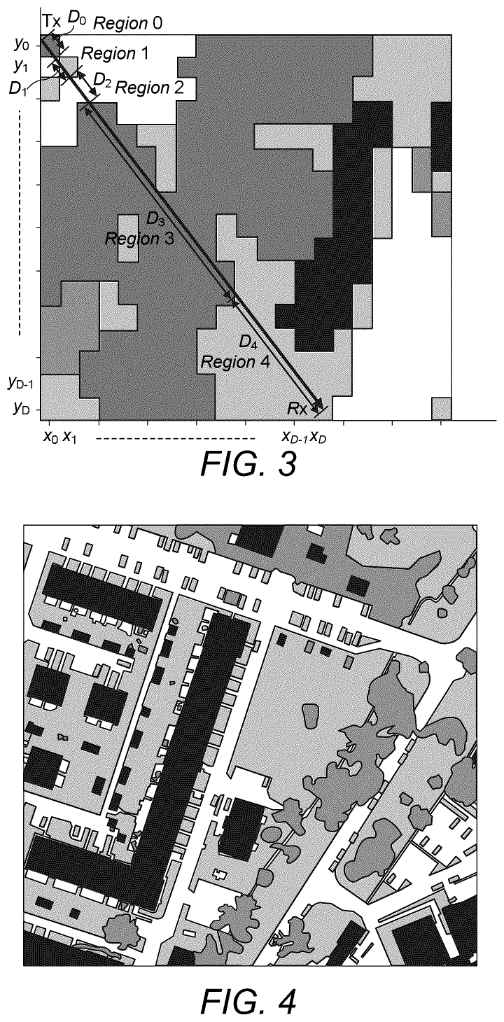

The path loss between the Tx (region 0 in FIG. 3) and the Rx (region N in FIG. 3) may be calculated as the accumulation of the path loss in decibel (dB) experienced in each region between the Tx and the Rx as shown below:

$$P L = {\sum }_{i = 0}^{N} P {L}_{i} \qquad ( 2 )$$

Where PLᵢ is the path loss experienced in region i, calculated as follows:

$$\{ \begin{matrix}P {L}_{0} = C \\ P {L}_{i} = 10 * {n}_{i} * {log}_{10} ( \frac{{Σ}_{j = 0}^{i} {d}_{j}}{{Σ}_{j = 0}^{i - 1} {d}_{j}} ) \end{matrix} \qquad ( 3 )$$

where C is the path loss at a referencing distance such as one meter and is a constant for a certain radio wave frequency; nᵢ is the path loss exponent of region i, which is only related to the environmental factor of this region; dⱼ is the distance of the path within region j; Σⱼ₌₀ⁱdⱼ is the distance of the path from region 0 to region i;

$${log}_{10} ( \frac{{\sum }_{j = 0}^{i} {d}_{j}}{{\sum }_{j = 0}^{i - 1} {d}_{j}} )$$

is the ratio related to the distance from region i to region 0 and the distance from region i−1 to region 0, where a region may contain one or more pixels and can be in a regular shape like a square or in an irregular shape. FIG. 3 illustrated a path from transmitter (Tx) to receiver (Rx) where dⱼ is the distance of one path loss exponent.

The measured path loss in 106 FIG. 1 is used to train the above path loss parameters to meet termination criteria in 108 FIG. 1. The termination criteria can be performed in various ways, which include but are not limited to L1, L2 or MMSE being smaller than a threshold, or keeping constant after several epochs, or reaching a maximum of running epochs. The update of the tuneable parameters can be performed using various algorithms, which include but are not limited to random update, gradient descent, etc, as would be understood by the skilled person.

In other words, an updating algorithm can determine an error (e.g. a difference) between the measured path loss and the calculated (e.g. predicted) path loss for each transmitter-receiver pair, and work to minimise those errors (e.g. differences) by adjusting the path loss exponent of each region. That is, the path loss exponents are tuneable parameters. The errors (e.g. differences) determined for the plurality of transmitter-receiver pairs may be combined (e.g. so as to define an L1, L2, or MMSE error, sometimes referred to as a “cost function”). The calculating, measuring and updating steps may be repeated until a termination criteria relating to that combined error (e.g. “cost function”) is met. For example, the updating algorithm may search in a solution space to find the path loss exponents that result in the minimum, or close to minimum, value of the cost function (e.g., L1, L2, or MMSE).

The path loss may not be directly measured and can be extracted from the measurement of the receiving power as: path loss=Tx power+Tx antenna gain+Rx antenna gain−received signal power.

For each transmitter-receiver pair, a measure of the path loss (e.g. a measure indicative of the path loss, such as receiving power) can be taken at the receiver (e.g. Rx), which indicates the path loss across the whole straight-line path between the transmitter (e.g. Tx) and the receiver (e.g. Rx) in that transmitter-receiver pair.

One transmitter (Tx) can be a member of more than one transmitter-receiver pair. For example, the scenario of interest may comprise one transmitter (Tx) and a plurality of receivers (Rx). The location of the transmitter (Tx) may be fixed. In an example, in order to obtain measurement data for a plurality of transmitter-receiver pairs, a mobile receiver can be moved about the scenario of interest, and a measure of the path loss (e.g. a measure indicative of the path loss, such as receiving power) can be taken by that mobile receiver at a plurality of receiver locations. That is, one physical receiver can be used to measure path loss values for a plurality of receivers in the scenario of interest. For example, the receiver may be placed on a vehicle (e.g. a car, van, or trolley). Said vehicle may move within the scenario of interest according to a specified route. In another example, in order to obtain measurement data for a plurality of transmitter-receiver pairs, crowd-sourced measurement data can be obtained from a number of mobile network subscribers' phones (e.g. where those phones act as receivers within the scenario of interest).

FIG. 4 shows an example figure with environmental factor labelling. Pixels with growing grey scales indicate road, grass, cars, foliage, and building. The intensity of greyscale regarding to different materials reflects the potential contribution of their path loss.

Hence, the invention can be summarized as follows: 1) establishing a straight line between each pair of transmitter (Tx) and receiver (Rx) in a coverage area; 2) segmenting each straight line into one to many regions along each Tx-Rx path according to how the environments impact radio propagation; 3) obtaining the path loss exponents for all of the regions; and 4) calculating the path loss for each pair of Tx and Rx, e.g. according to equation (3).

In other words, a scenario of interest (e.g. coverage area) can be segmented into a plurality of regions (e.g. including regions A, B, C, D and E). Each region is assigned a path loss exponent (e.g. n_{A}, n_{B}, n_{C}, n_{D}, N_{E}). The scenario of interest includes at least one transmitter (Tx) and at least one receiver (Rx). A respective straight-line path is plotted for each of a plurality of transmitter-receiver pairs (e.g. Tx and Rx). It is to be understood that one transmitter (Tx) can be a member of more than one transmitter-receiver pair. Similarly, it is to be understood that one receiver (Rx) can be a member of more than one transmitter-receiver pair. For each transmitter-receiver pair, the path loss between the transmitter (Tx) and the receiver (Rx) is calculated by accumulating the predicted path loss in each region crossed by the straight-line path plotted for that transmitter-receiver pair. This can be termed “predicted data”. The predicted data may comprise a plurality of calculated values (e.g. a calculated value for each transmitter-receiver pair). For each transmitter-receiver pair, the path loss calculation can depend on the path loss exponent (e.g. n_{A}, n_{B}, n_{C}, n_{D}, N_{E}) of each region crossed by the straight-line path plotted for that transmitter-receiver pair, and the length of (e.g. distance covered by) that straight-line path within each region. For each transmitter-receiver pair, the path loss between a transmitter (e.g. Tx) and a receiver (e.g. Rx) in the same arrangement is also measured (e.g. in “real-life”). For each transmitter-receiver pair, a measure of the path loss (e.g. a measure indicative of the path loss, such as receiving power) can be taken at the receiver (e.g. Rx), which indicates the path loss across the whole straight-line path between the transmitter (e.g. Tx) and the receiver (e.g. Rx) in that transmitter-receiver pair. This can be termed “measurement data”. The measurement data may comprise a plurality of measured values (e.g. a measured value for each transmitter-receiver pair). The path loss exponent for each of the regions (e.g. n_{A}, n_{B}, n_{C}, n_{D}, n_{E}) can be updated in dependence on the predicted data and the measurement data. For example, the path loss exponent for each of the regions (e.g. n_{A}, n_{B}, n_{C}, n_{D}, n_{E}) can be updated by assessing the differences between (e.g. the error in) the respective calculated and measured path losses for each transmitter-receiver pair. An updating algorithm can determine an error (e.g. a difference) between the measured path loss and calculated path loss for each transmitter-receiver pair, and work to minimise those errors (e.g. differences) by adjusting the path loss exponents. The errors (e.g. differences) defined for each transmitter-receiver pair may be combined (e.g. so as to define an L1, L2, or MMSE error, sometimes referred to as a “cost function”), and the calculating, measuring and updating steps may be repeated until a termination criteria relating to that combined error is met.

The path loss exponent calculated according to the principles described herein can be used to plan a radio access network. In other words, the path loss exponent calculated according to the principles described herein can be used in the process of configuring a wireless communications system (e.g. radio access network) for implementation. The path loss exponent calculated according to the principles described herein is much more accurate than the empirical models that are currently used. Once the model has been trained, the time to calculate the path loss is much shorter than deterministic models. In addition, the path loss exponent can become an attribute of digital maps. Finally, a wireless communications system (e.g. radio access network) configured using a more accurate path loss exponent (i.e. a path loss exponent calculated according to the principles described herein) is technically improved (e.g. provides better connectivity) than a wireless communications system designed based on the empirical models that are currently used.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method of radio path loss calculation considering parameterized environmental factors, the method comprising:
(a) segmenting a scenario of interest into a plurality of regions;
(b) labelling each region with an environmental factor, wherein the environmental factor of each region is mapped to a path loss exponent;
(c) initializing a path loss exponent for each region;
(d) for each of a plurality of pairs of transmitter and receiver in the scenario of interest, generating straight-line path information, including a straight-line path between a transmitter (Tx) and a receiver (Rx) in the scenario of interest;
(e) for each of the plurality of pairs of transmitter and receiver in the scenario of interest, calculating the path loss between the transmitter (Tx) and the receiver (Rx) by accumulating the path loss of each region crossed by the straight-line path between that transmitter (Tx) and that receiver (Rx), so as to obtain calculated values;
(f) for each of the plurality of pairs of transmitter and receiver in the scenario of interest, obtaining a measure of the path loss between the transmitter (Tx) and the receiver (Rx), so as to obtain measurement data;
(g) updating the environmental factor-related path loss exponent of each region in dependence on the calculated values and the measurement data;
(h) iterating the steps (e) to (g) until predefined termination criteria are reached; and
(i) outputting the updated path loss exponent of each region for future path loss prediction or training.

2. The method as claimed in claim 1, wherein the method can be applied to any frequency band.

3. The method as claimed in claim 1, wherein each region comprises one or more pixels and is regular or irregular in shape, and wherein each region comprises any one or more of: a building, a group of buildings, a group of foliage, one or more humans, one or more vehicles, or other objects.

4. The method as claimed in claim 1, wherein the environment factors include any one or more of: building(s), road(s), foliage, rain, snow, vehicle(s), human(s), furniture, landscaping, terrain, climatic conditions, or other obstacles.

5. The method as claimed in claim 1, wherein a pixel-wise labelling method is used to perform the labelling step (b), the pixel-wise labelling method including any one or more of the following approaches:
manual labelling;
automatic labelling using algorithms based on a machine learning framework to recognise geographic information, optionally wherein the said machine learning framework is a neural network (NN) method.

6. The method as claimed in claim 1, wherein in the labelling step (b), a label for each region is calculated based on:
a mean greyscale value of all the pixels that that region consists of, or
a weighted greyscale value of all the pixels that that region consists of.

7. The method as claimed in claim 1, wherein initializing the path loss exponent for each region includes any one or more of the following approaches:
initializing the path loss exponent based on a pre-trained model;
initializing the path loss exponent randomly;
initializing the path loss exponent manually;
initializing the path loss exponent based on measurement data; and
initializing the path loss exponent based on theoretically calculated values.

8. The method as claimed in claim 1, wherein generating the straight-line path information between the Tx and the Rx comprises generating a matrix comprising the straight-line path information, the matrix having the form:
$$( \begin{matrix}{X}_{1} ( {X}_{S} ) & {X}_{2} & {X}_{3} & & {X}_{{N}_{k} - 2} & {X}_{{N}_{k} - 1} & {X}_{{N}_{K}} ( {X}_{{D}_{k}} ) \\ {Y}_{1} ( {X}_{S} ) & {Y}_{2} & {Y}_{3} & … & {Y}_{{N}_{k} - 2} & {Y}_{{N}_{k} - 1} & {Y}_{{N}_{K}} ( {Y}_{{D}_{k}} ) \\ {d}_{1} & {d}_{2} & {d}_{3} & & {d}_{{N}_{k} - 2} & {d}_{{N}_{k} - 1} & {d}_{{N}_{k}}\end{matrix} )$$
where the straight line, starting from the Tx region (X_{S}, Y_{S}) and ending at the Rx region (X_{D}_{ₖ}, Y_{D}_{ₖ}), crosses Nₖ regions in total, the first and second rows denote the X and Y coordinates of the Nₖ regions, respectively, (X₁, Y₁) is the position of the Tx and (X_{N}_{ₖ}, Y_{N}_{ₖ}) is the position of the Rx, and the third row denotes the distance of the path travelled within each one of the Nₖ regions.

9. The method as claimed in claim 1, wherein the path loss PLᵢ of the i-th region in the straight-line path comprises:
the path loss experienced at the region of the Tx, calculated as:
PL₀=C
where C is a constant; and
the path loss experienced at each one of the other regions, calculated as:
$${PL}_{i} = 10 * {n}_{i} * {log}_{10} ( \frac{{Σ}_{j = 0}^{i} {d}_{j}}{{Σ}_{j = 0}^{i - 1} {d}_{j}} )$$
where nᵢ is the path loss exponent of region i, which is dependent on the environmental factor for that region, dⱼ is the distance of the path within region j, Σⱼ₌₀ⁱdⱼ is the distance of the path from the region of the Tx to region i, and
$${log}_{10} ( \frac{{\sum }_{j = 0}^{i} {d}_{j}}{{\sum }_{j = 0}^{i - 1} {d}_{j}} )$$
is the ratio between the distance from region i to the region of the Tx and the distance from region i−1 to the region of the Tx.

10. The method as claimed in claim 9, wherein the path loss experienced in each region is accumulated to calculate the total path loss, i.e. PL, between the Tx and the Rx, calculated as:
$$PL = {\sum }_{i = 0}^{{N}_{k}} {PL}_{i}$$

11. The method as claimed in claim 1, wherein updating the environmental factor-related path loss exponent further comprises:
calculating an error between the measurement data and the calculated values; and
updating the environmental factor-related path loss exponent of each region depending on the calculated error.

12. The method as claimed in claim 11, wherein the error between the measurement data and the calculated values is computed using any of the following errors:
the sum of all of the absolute differences between the measured values and the calculated values;
the sum of all of the squared differences between the measured values and the calculated values; or
the minimum mean square error (MMSE) between the measured values and the calculated values.

13. The method as claimed in claim 11, wherein updating the environmental factor-related path loss exponent of each region includes any of the following approaches:
manually updating;
updating using optimization algorithms, which include any one or more of simulated annealing, or genetic algorithm;
updating using machine learning algorithms, which include any one or more of neural network methods, or reinforcement learning methods.

14. The method as claimed in claim 1, wherein the predefined termination criteria include any of the following criteria:
the error being smaller than a threshold;
the error keeping constant after several consecutive epochs; or
a maximum number of running epoch is reached.

15. The method as claimed in claim 1, wherein the path loss exponent of each region can be an attribute of a digital map in any format such as Google Maps, Bing Maps, Street Maps, and any Geographic Information Systems.
